(19) United States
(12) Patent Application Publication
(10) Pub. No.: US 2010/0235256 A1
(43) Pub. Date: Sep. 16, 2010

(54) SYSTEM FOR ONLINE CONTENTS MARKETPLACE AND THE OPERATION METHOD THEREOF

(76) Inventor: Chan Goo Kang, Daejon (KR)

Correspondence Address: DOYLE B. JOHNSON;REED SMITH LLP, PO BOX 7936, SAN FRANCISCO, CA, 94120-7936, US

(21) Appl. No.: 12/298,289

(22) PCT Filed: Apr. 17, 2007
(86) PCT No.: PCT/KR2007/001864

§ 371 Date: May 24, 2010

(30) Foreign Application Priority Data
Apr. 29, 2006 (KR) 10-2006-0039103
Jun. 5, 2006 (KR) 10-2006-0050224

(51) Int. Cl. G06Q 30/00; G06F 17/30; G06F 17/00; G06Q 50/00; G06Q 99/00

(52) U.S. Cl. 705/27; 707/769; 707/802; 715/234; 707/E17.044; 707/E17.108; 707/E17.005

(57) ABSTRACT

The present invention relates to an online content marketplace system and a method of operating the system, in which the authors of personal media content can share their writing, individuals or groups can purchase necessary shared content, and purchased content is provided such that it can be conveniently and effectively used. Using an online content marketplace system including a content sale means (100), a content purchase means (200), a content marketplace server (300), and a data communication network (400), a content seller uploads content to his or her personal media site such as a blog, when the intention to publicly post the content is disclosed, corresponding content is registered in a posting-authorized content DB, a content purchaser purchases desired content posted on a marketplace, and content can be posted on a his or her company website only by inserting a simple script code thereto.

### TECHNICAL FIELD

The present invention relates, in general, to an online content marketplace system and a method of operating the system for facilitating the trade and easy use of personal media content using an information communication network, and, more particularly, to an online content marketplace system and a method of operating the system in which the authors of personal media content can share their writing, in which individuals or groups can purchase necessary shared content, and in which purchased content is provided such that it can be conveniently and effectively used.

### BACKGROUND ART

In general, typical content producers' profit creation methods using personal media (hereinafter referred to as “blogs”) are classified into two types. The first type of method is a method of making profits by posting the advertisements of other websites using affiliate programs (Google AdSense or Amazon Associates Program), and the second type of method is a method of making profits by converting content itself into offline content and selling it.

The first type of method is a method in which service providers share profits, obtained through the posting of advertisements, with users who have posted the advertisements. The second type of method is a method in which companies share profits, obtained through the conversion of content into offline content, with content producers.

However, the first type of method has a problem in that profits depend on the overall popularity of blogs rather than on the quality of content itself.

Meanwhile, the second type of method has a problem in that content, which is actually provided offline, can be viewed, so that sufficient profits are not created.

In the meantime, although the amount of production of personal media content is rapidly increasing, the number of profit models for creating profits using content itself online is small.

Generally, most personal media content that is considered worthy of being charged for is informative content. Actual systems for making profits using emotional content, rather than using informative content, cannot be found.

Meanwhile, Google's AdSense program may be taken as an example of showing dynamic content through the insertion of a scripting language. With regard to AdSense, when a user inserts a simple JavaScript code into his or her own webpage, AdSense analyzes the content of the current page, receives an advertisement suitable for the context of the webpage from the Google advertisement DataBase (DB), and dynamically displays the advertisement.

Although this technology is significant in that service is provided to allow content producers to make profits, there is concern about the production of a great many spam blogs (blogs in which many AdSense programs are inserted into websites having low-quality content or meaningless content and which are used td earn money by deceiving people) that are intended to make profits by abusing the above-described programs.

### DISCLOSURE

### Technical Problem

Accordingly, the present invention has been made keeping in mind the above problems occurring in the prior art, and is intended to achieve the following objects.

(1) The authors of personal media content can share their writing, individuals or groups can purchase necessary shared content, and purchased content can be conveniently and effectively used.

That is, the authors of personal media can publish and share content, produced by them, via a writing content-related DB, which is constructed using the meta-information or indices of the writing, and third parties and users can purchase the content and easily post it on their websites, thereby allowing the authors of the content to make profits and the users of the content to efficiently gain publicity for their websites, the creation of new meta-sites and other purposes.

(2) Profits can be made not only from informative writing, which is generally considered to be useful, but also from sufficiently useful writing, particularly writing related to experience.

(3) Aggregation sites, that is, webzines (Internet magazine)-type websites, which are configured by directly purchasing various personal media content, collecting it and showing it, can be easily constructed.

(4) In the case where the object of the purchase of content is to promote a website or a product, a customer can accurately know the product being purchased at the time of payment of money, so that a targeted flow is formed from the point of view of the flow of money, thereby achieving efficient management compared to existing approaches, such as banner advertising or AdSense.

(5) Website operators can use content produced by other persons on their websites and prevent website visitors from moving to other websites so as to access the content, thereby effectively showing the content while preventing the users from losing the current context.

### Technical Solution

The characteristics and advantages of the present invention will be further apparent from the following detailed description based on the accompanying drawings. It should he noted that detailed descriptions of well-known functions and constructions related to the present invention will be omitted below when they could make the gist of the present invention unclear.

An online content marketplace system according to a first embodiment of the present invention will be described with reference to the accompanying drawings below.

The online content marketplace system according to the first embodiment, as shown in FIG. 1, includes a content sale means (100), a content purchase means (200), a content marketplace server (300), and a data communication network (400).

In detail, the content sale means (100) includes a content seller terminal (110) and a content provision webpage (120). The content seller terminal (110) makes online access to the content provision webpage (120), and posts produced content on the content provision webpage (120). In this case, a content seller transmits a message (hereinafter referred to as the “sale offer message”) indicating that he or she desires to share and sell the content, posted on his or her own content provision webpage (120), to the content marketplace server (300) using the content seller terminal (110). The sale offer message is a message that is identical to the following posting authorization message.

Meanwhile, the content seller may indicate his or her intention to share and sell the content while posting the content via the content provision webpage (120), instead of using the sale offer message. The indication of the intention to sell content may be implemented by inserting a specific token into the content itself or by attaching metadata to the content. Alternatively, the indication of the intention to sell content may be implemented using a method of inserting a script or a dynamic component, capable of communicating with the marketplace server (300), into the content itself using simple tags and transmitting a sale offer message, which is also used as a kind of metadata. For reference, in the latter case, using a script or dynamic component, the technical operations and the corresponding flow of the operations, which will be described later, are changed. The latter case will be described in the following description of the second embodiment.

The content purchase means (200) includes a content purchaser terminal (210) and a purchaser webpage (220). The content purchaser terminal (210) allows a content purchaser to make online access to the content marketplace server (300), to search or scan content for sale, registered in the content marketplace server (300), and then to purchase the content. The content purchaser makes online access to the purchaser webpage (220) using the content purchaser terminal (210), and inputs a script code for inserting purchased content. When the content purchaser inputs the script code on the purchaser webpage (220), the corresponding content is entered in the purchaser webpage (220), and is exposed to users who make online access to the purchaser webpage (220).

The content marketplace server (300), as shown in FIG. 2, includes a seller information DB (301) for storing content seller profile information in association with seller Identification (ID) information; a purchaser information DB (303) for storing content purchaser profile information in association with purchaser ID information; a posting-authorized content DB (305) for storing content, authorized for posting by content sellers, in association with the seller ID information; a sold content DB (307) for storing content information that belongs to the content registered in the posting-authorized content DB (305) and has been sold; a payment information DB (309) for storing payment information, created in the event of selling and purchasing; a seller information management module (311) for creating seller ID information when content sellers perform registration for membership, and registering and managing seller profile information, input by the content sellers, in the seller information DB (301) in association with the seller ID information; a purchaser information management module (313) for creating purchaser ID information when content purchasers perform registration for membership, and registering and managing purchaser profile information, input by the content purchasers, in the purchaser information DB (303) in association with the purchaser ID information; a content posting authorization message reception module (315) for checking whether a content posting authorization message has been received from the content seller terminal (110), and creating and outputting uploading information for content authorized for posting if the content posting authorization message is received; a sale content collection module (317) for checking whether uploading information is input from the posting authorization message reception module (315), if the uploading information is input, collecting content corresponding to the uploading information and then registering and managing the content in the posting-authorized content DB (305) in association with the seller ID information, checking whether a specific token or metadata is included in content posted on the web, and, if, as a result of the determination, the specific token or metadata is included, collecting the content and then registering and managing the content in the posting-authorized content DB (305) in association with the seller ID information; a seller-based content management module (319) for managing only content, the posting of which has been authorized by a content seller, in association with seller ID information; a content sale module (321) for providing a service so that a certain purchaser can search and scan the content registered in the posting-authorized content DB (305) and purchase specific content based on the results of the searching and scanning; a purchaser-based content management module (323) for, in the case where a specific purchaser purchases specific content through the content sale module (321), managing the content in association with purchaser ID information; a content posting webpage link module (325) for, in the case where specific content is sold, including link information for a webpage, on which the sold content has been posted, in the sold content, so that the webpage can be provided when the content is clicked on; a payment management module (327) for, in the case where specific content is sold by the content sale module (321), receiving payments for the content from a purchaser, paying the payments for the content to a content seller, and registering and managing payment information, created after payment, in the payment information DB (309).

The posting-authorized content DB (305) also contains indices based on indexing, and metadata, such as tags included in content directly by content sellers.

The content collection module (317) creates and manages document ID information for content the posting of which is authorized by the sellers. In this case, the content collection module (317) includes a ping handler for receiving posting authorization messages and a crawling engine for reading tags or metadata included in content. Meanwhile, the content collection module (317) stores only the ID information of posting-authorized content in the seller information DB (301), and registers and manages information, such as the permalinks of the actual content, the content itself or Uniform Resource Locators (URLs), that is, web addresses, in the posting-authorized content DB (305).

### DESCRIPTION OF DRAWINGS

FIG. 1 is a diagram illustrating an online content marketplace system according to a first embodiment of the present invention;

FIG. 2 is a diagram illustrating the construction of a content marketplace server that is applied to FIG. 1;

FIG. 3 is a flowchart illustrating a routine for collecting posting-authorized user content in a method of operating an online content marketplace system according to a first embodiment of the present invention;

FIG. 4 is a flowchart illustrating a routine for searching, scanning and purchasing content in a marketplace in the method of operating an online content marketplace system according to the first embodiment of the present invention;

FIG. 5 is a flowchart illustrating a routine for automatically embedding content into a website in the method of operating an online content marketplace system according to the first embodiment of the present invention;

FIGS. 6a and 6b are screen views illustrating a method of automatically embedding content into a website according to the first embodiment of the present invention;

FIG. 7 is a flowchart illustrating a routine for collecting posting-authorized user content in a method of operating an online content marketplace system according to a second embodiment of the present invention;

FIG. 8a is a diagram illustrating the construction of a content marketplace server according to the second embodiment of the present invention;

FIG. 8b is a flowchart illustrating a routine for automatically purchasing content according to the second embodiment of the present invention;

FIG. 9 is a flowchart illustrating a routine for automatically embedding content into a website in the method of operating an online content marketplace system according to the second embodiment of the present invention; and

FIG. 10 is a screen view illustrating a method of automatically embedding content into a website according to the second embodiment of the present invention.

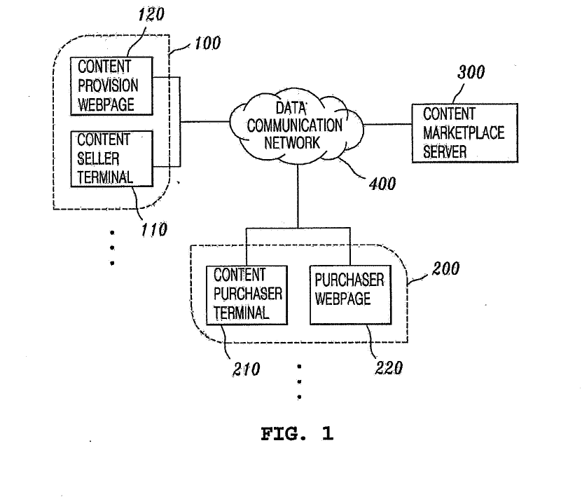

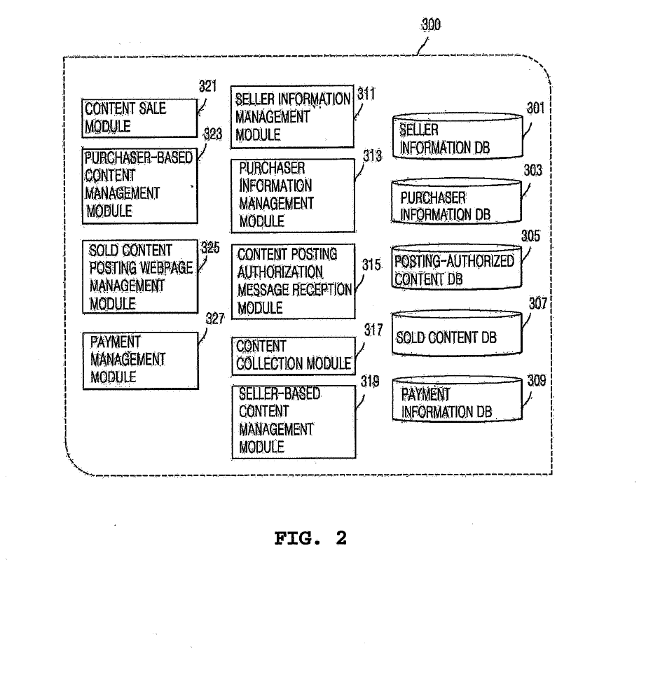

### DESCRIPTION OF REFERENCE CHARACTERS OF PRINCIPAL ELEMENTS IN THE DRAWINGS

100: content sale means 200: content purchase means
300: content marketplace server
301: seller information DB
303: purchaser information DB
305: posting-authorized content DB
307: sold content DB
309: payment information DB
311: seller information management module
313: purchaser information management module
315: content posting authorization message reception module
317: content collection module
319: seller-based content management module
320: automatic content purchase module
321: content sale module
323: purchaser-based content management module
325: purchased content posting webpage management module
329: payment management module

### Best Mode

A method of operating an online content marketplace system having the above-described construction will be described below.

[Routine for Collecting Posting-Authorized User Content According to First Embodiment]

First, in order to sell content that has been posted on a personal medium, such as a blog or a personal homepage, or on a typical webpage created by a content seller himself or herself, the content seller sends a content posting authorization message to the content marketplace server 300 using a Trackback, XML-RPC or HTTP request method, or includes a tag (metadata), having an indication of authorization for posting in content or a specific token in content.

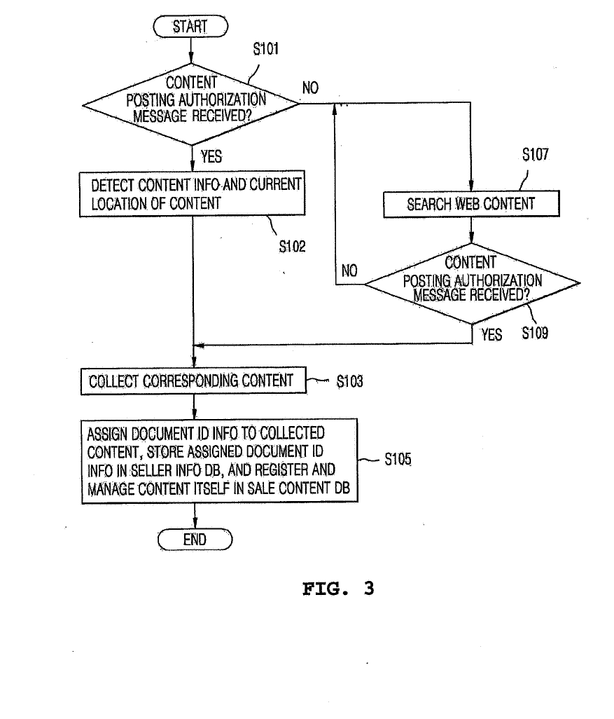

Taking the foregoing description into consideration, the routine in which the content collection module 317 of the content marketplace server 300 collects posting-authorized content so as to sell the content is illustrated in the attached FIG. 3.

The content collection module 317 determines whether a content posting authorization message is received via a data communication network 400 at step S101.

If, as a result of the determination at step S101, the content posting authorization message is received, the content collection module 317 detects content information and the current location of the content using the posting authorization message at step S102, and collects the corresponding content at step S103.

The content collection module 317 issues and assigns document ID information to the collected content, registers and manages the ID information of the content in the content seller information DB 301, and registers and manages the content itself in the posting-authorized content DB 305 at step S105. In this case, the posting-authorized content DB 305 contains not only content itself but also other information, indices obtained through indexing, and tags and metadata in the case where a content seller directly includes metadata, such as a tag (notes), in content.

Meanwhile, if, as a result of the determination at step S101, the content posting authorization message is not received, the content collection module 317 searches web content at step S107.

Furthermore, the content collection module 317 determines whether a specific token or metadata is included in the searched content at step S109. If, as a result of this determination, a specific token or specific metadata is included in the content, the process performs the steps starting from step S103.

The seller-based content management module 319 provides a webpage in which a content seller views only corresponding content using seller ID information if the content seller desires, and allows the content seller to modify the content via the webpage, with regard to the content ID collected by the content collection module 317 and registered in the content seller information DB 301, and the content collected by the content collection module 317 and registered in the posting-authorized content DB 305.

[Routine for Searching, Scanning and Purchasing Content in Marketplace According to First Embodiment]

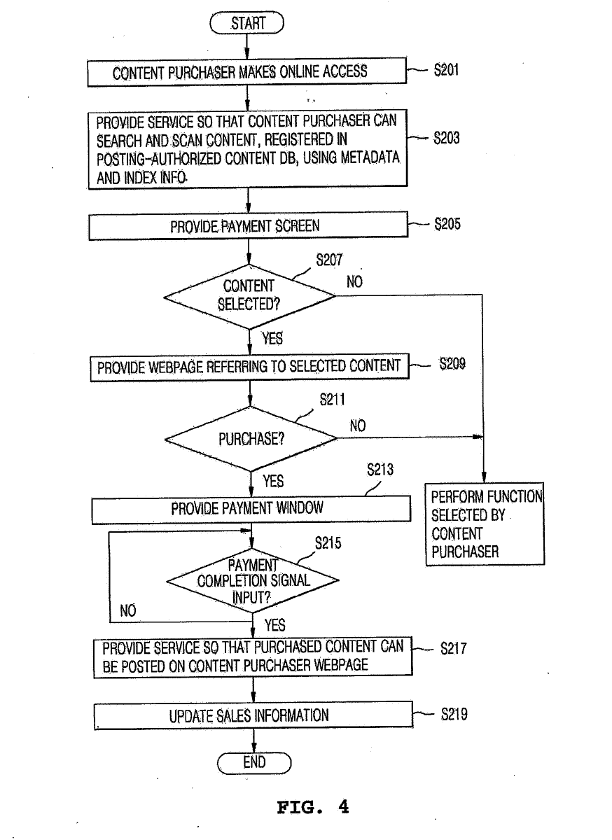

In the routine for positioning content in a marketplace, when a content purchaser makes online access at step S201, the content sale module 321 provides a service so that the content purchaser searches and scans the content, registered in the posting-authorized content DB 305, using meta-information and index information at step S203, as shown in the attached FIG. 4.

The content sale module 321 provides a result screen when a user completes searching and scanning at step S205.

The content sale module 321 determines whether the content purchaser has selected content on the result screen at step S207, and provides a webpage referring to the selected content if, as a result of the determination, the content has been selected at step S209. That is, the content purchaser purchases desired content, is provided with information about websites posting the content, and may visit the websites and check how the content is being used.

The content sale module 321 determines whether the content purchaser desires to purchase content on the result screen at step S211. If, as a result of the determination, the content purchaser desires to purchase the content, the content sale module 321 causes the payment management module 327 to provide a payment window to the content purchaser terminal 200 at step S213, so that the content purchaser makes payment, and determines whether a payment completion signal is received from the payment management module 327 at step S215. In this case, the payment management module 327 provides n % of the amount of money, paid by the content purchaser, to the content seller, and uses 100-n % for the operational expenses of the online content marketplace system.

For reference, when content is sold, the flow of money is basically directed from the content purchaser to the content seller as described above. Reversely, the flow of money may be allowed to be directed from the content seller to the content purchaser. For example, in order to post his or her own document on a specific part of a specific website, a content provider (seller) may pay a specific amount of money to the owner of the insertion component (content purchaser) and then post his or her document. Of course, in this case, the payment management module 327 provides n % of the amount of money, paid by the seller, to the content purchaser, and uses 100-n % as the operational expenses. The reverse flow of money may be appropriately used according to the market principle of supply and demand. In some cases, it will be possible to eliminate the flow of money and exchange only content.

If, as a result of the determination at step S215, the payment is completed, the content sale module 321 provides the purchased content so that the purchased content can be posted on the content purchaser webpage at step S217.

If the purchase of the content is completed, the content sale module 321 registers the ID information of the sold content in the sold content DB 307, and causes sales information to be updated at step S219. Thereafter, the purchaser-based content management module 323 reads the ID information of the purchased content from the posting-authorized content DB 305, and adds it to the purchaser information DB 303.

The content information registered in the purchaser information DB 303 automatically creates purchase content management webpages personalized for respective purchasers, so that the content purchaser can check the purchased content using the content purchaser terminal 200. That is, the content purchaser can easily check the list of purchased content and related information via the content management webpage.

As a result, in the online content marketplace system according to the present invention, content purchasers purchase content via the content marketplace server 300 and insert the content into their websites, thereby seeking various effects. At the same time, the inflow of a targeted user group can be sought through the contact with viewer users, which occurs in service websites provided with the same service via the content marketplace server 300 and which is generated by content purchased by the users.

The reason why the term “targeted” can be used is that users' intention is sufficiently satisfied if the users who are viewing content in service websites through scanning via metadata or searching via index information will visit other websites referring to the content via the activity known as “mouse clicking” because they want to learn about the websites.

[Routine for Automatically Embedding Content in Website According to First Embodiment]

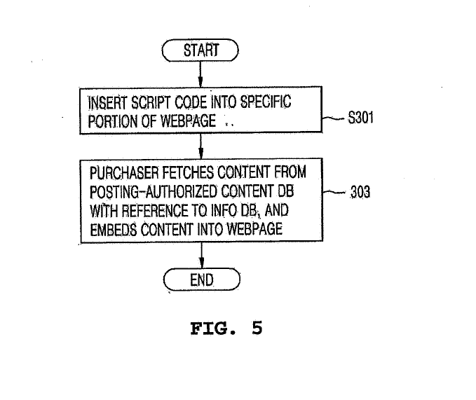

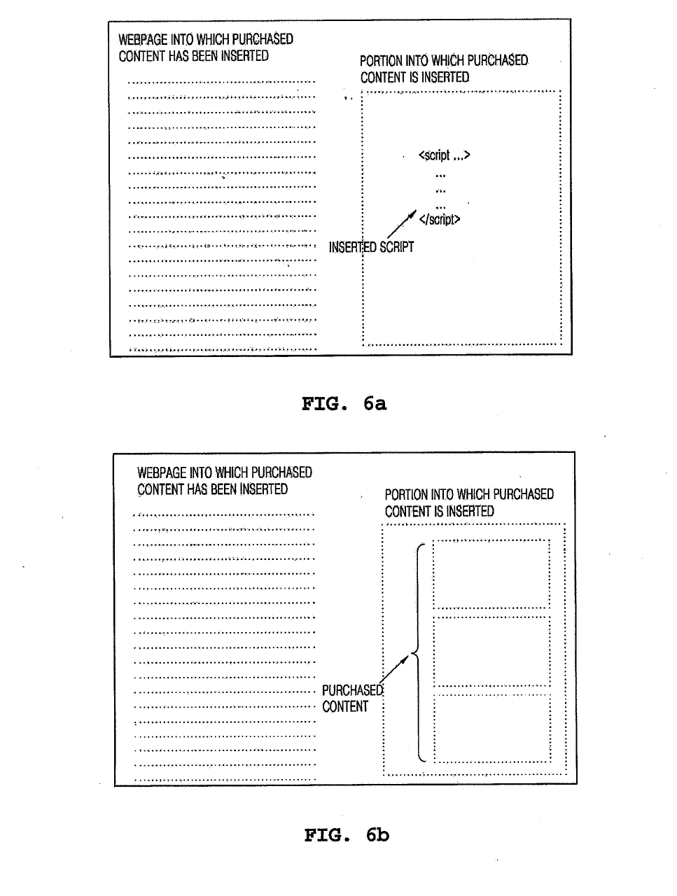

Referring to the attached FIG. 5, after purchasing specific content, the content purchaser makes online access to the purchaser webpage 220, and then inserts a simple script code, such as a JavaScript code, into a specific portion of a webpage at step S301. An example of the inserted code is illustrated in FIG. 6a.

Then, the script code detects the ID information of the corresponding content via the purchaser information DB 303, searches for the content, registered in the posting-authorized content DB 305, using the detected ID information of the content, fetches the corresponding content, and embeds the corresponding content into the corresponding region of the purchaser webpage 220 at step S302, as shown in FIG. 6b.

Here, the script code may be implemented to visualize and provide the purchased content in various ways. Furthermore, the script code is implemented such that displayed dynamic content can represent original content to the extent that it is not necessary for a user to access a corresponding webpage. The inserted content, automatically created and provided, may or may not provide a link to original posted content.

An online content marketplace system and a method of operating the system according to a second embodiment of the present invention will be described below. Herein, since the construction of the system of the second embodiment is mostly the same as that of the first embodiment, a description thereof is replaced with the above description of the construction of the system of the first embodiment. However, characteristic elements will be described below along with part of the operation method that is distinguished from that of the operation method of the first embodiment.

[Routine for Collecting Posting-Authorized User Content According to Second Embodiment]

First, in order to sell a content seller's own content, the content seller inserts a script or a dynamic component, such as a Flex or Laszlo component, capable of directly communicating with the posting authorization message reception module 315, into the content.

Here, the dynamic component can detect the address information of a webpage into which it has been inserted, and can send a posting authorization message to the content posting authorization message reception module 315 along with various information, including the address of the webpage to which the dynamic component belongs, when the production of content is completed and the webpage including the content is loaded for the first time.

In other words, this means that the content posting authorization message reception module 315 can identify the location (address) of the webpage into which the component has been inserted. Furthermore, the fact that the component has been inserted into the content itself means that a content producer inserted the component into the content when producing the content, and this means that the posting of the content was authorized, so that it is naturally verified that the content producer is the same as a content posting authorizer without requiring direct subscription to the content marketplace server 300.

However, there is a case where the component or script cannot detect the address of the webpage into which the component or script has been inserted due to the unique setting of a website. In this case, the address of the content can be detected using the referrer log of a web server. The term “referrer log” refers to information about the address of a page on which an image is loaded or information about the address of a page to which a link belongs at the time of accessing a web server via the link in the case where the image or link has been inserted into the webpage, which remains in the log of the web server.

For example, when a specific image file existing in the content marketplace server is inserted into a page using a tag, such as “<img>”, and the page is loaded, the website that refers to the image can be found by analyzing the referrer log of the marketplace web server. Since the fact that an item (hereinafter referred to as ‘referrer information’), which can leave a referrer log in the marketplace server, such as the image, has been inserted into content means that a content producer inserted it into the content when producing the content as described above, it is verified that the content producer is the same as a content posting authorizer without direct subscription to the content marketplace server 300 as described above.

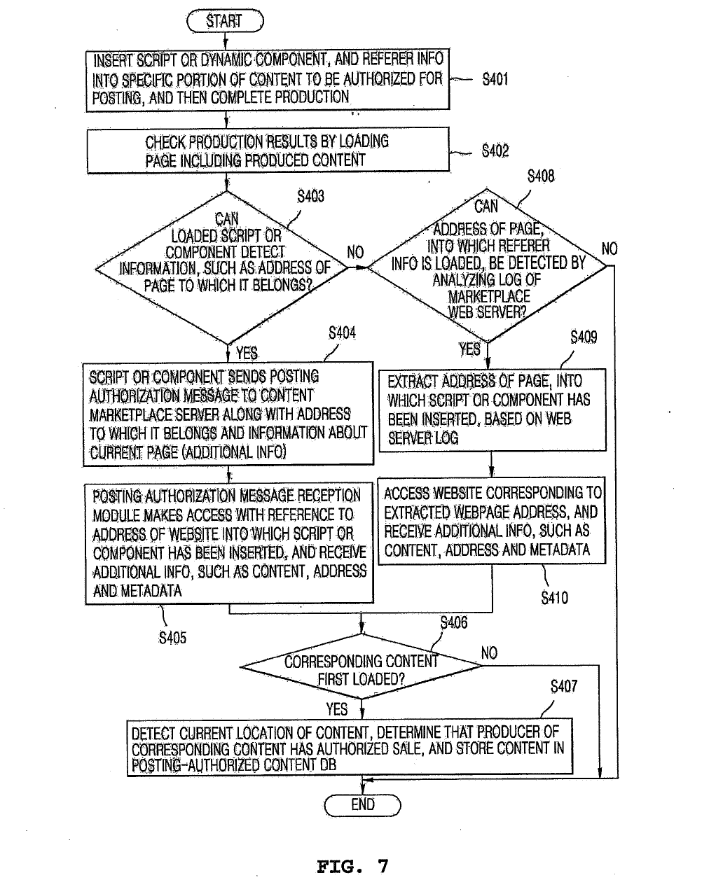

The above-described issue will be described in greater detail with reference to the attached FIG. 7 below.

A content seller inserts a script or a dynamic component into a specific portion of content along with referrer information, and completes the production of the content at step S401.

After the production of the content at step S401, the content seller loads a page, including content produced by him or her, and checks the results of the production at step S402. The loaded script or dynamic component determines whether to detect information, such as the address of a page to which it belongs, at step S403.

If, as a result of the determination at step S403, the information cannot be detected, the script or component sends a posting authorization message, including the address to which the script or component belongs and information about a current page (hereinafter ‘additional information’), to the content marketplace server 300 at step S404.

Subsequently, the content posting authorization message reception module 315 of the content marketplace server 300 accesses the website into which the corresponding script or component has been inserted based on the additional information, and receives additional information, such as content, an address and metadata, at step S405.

The content posting authorization message reception module 315 determines whether the script or component has been loaded for the first time at step S406. If the script or component has been loaded for the first time, the seller-based content management module 319 of the content marketplace server 300 detects the current location of the content, determines that the producer of the corresponding content authorized the sale of the content, and stores the content in the posting-authorized content DB 305 at step S407.

Meanwhile, if, as a result of the determination at step S403, the information cannot be detected, the content posting authorization message reception module 315 determines whether to detect the address of a page on which referrer information is loaded using the log of the web server of the marketplace at step S408.

If, as a result of the determination at step S408, the information can be detected, the content posting authorization message reception module 315 extracts the address of the page into which the script or component has been inserted based on the log of the web server at step S409.

Thereafter, the content collection module 317 accesses a website corresponding to the address of the page extracted at step S409, and receives supplementary information, such as content, an address and metadata, at step S410. Subsequently, the foregoing step S406 is performed.

[Routine for Automatically Purchasing Content According to Second Embodiment]

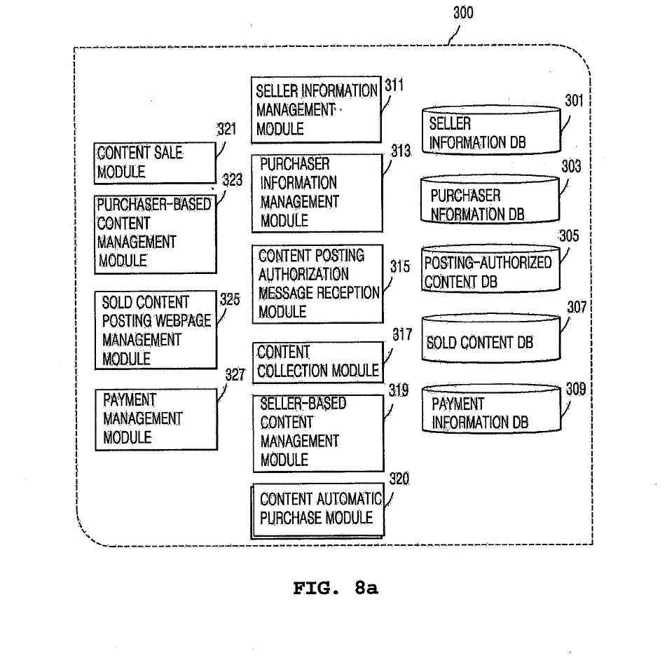

Meanwhile, in the method of operating the online content marketplace system according to the present invention, the content marketplace server 300 may provide the service of automatically purchasing content corresponding to purchase condition information even in the case where the content purchaser does not make online access in such a way that the content purchaser sets various conditions (hereinafter referred to as ‘purchase condition information’), such as metadata and query filters, in advance. For this purpose, the content marketplace server 300, as illustrated in FIG. 8a, includes an automatic content purchase module 320 in addition to the construction of the system of the first embodiment.

A detailed description will be made with reference to FIG. 8b. A content purchaser (a content purchaser terminal) sets the purchase condition information in the purchaser webpage 220 at step S501, and the automatic content purchase module 320 stores the purchase condition information in the purchaser information DB 303 at step S502.

Subsequently, the automatic content purchase module 320 determines whether the posting-authorized content and the metadata thereof coincide with the purchase condition information previously stored in the purchaser information DB 303 at step S503. If the posting-authorized content and the metadata thereof coincide with the purchase condition information, the automatic content purchase module 320 updates sales information by registering the ID information of the content in the sold content DB 307 at steps S504 and S505.

Thereafter, the purchaser-based content management module 323 retrieves the ID information of the content from the posting-authorized content DB and adds the ID information of the content to the purchaser information DB 303 at step S506.

[Routine for Automatically Embedding Content into Website According to Second Embodiment]

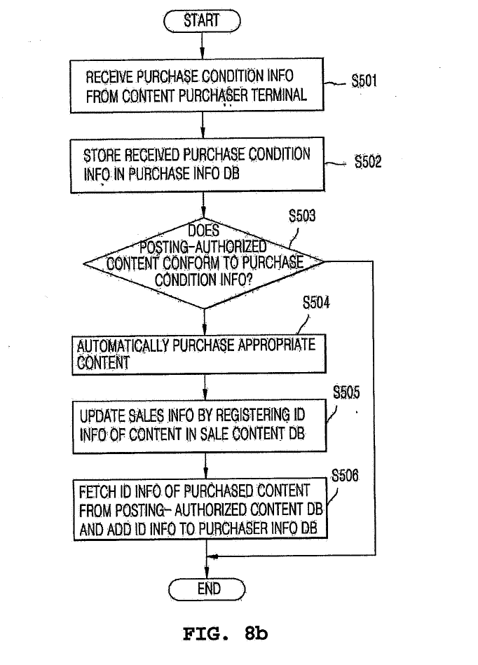

Meanwhile, according to the second embodiment of the present invention, the routine of the attached FIG. 9 may be used in the same manner as the automatic embedding of the first embodiment.

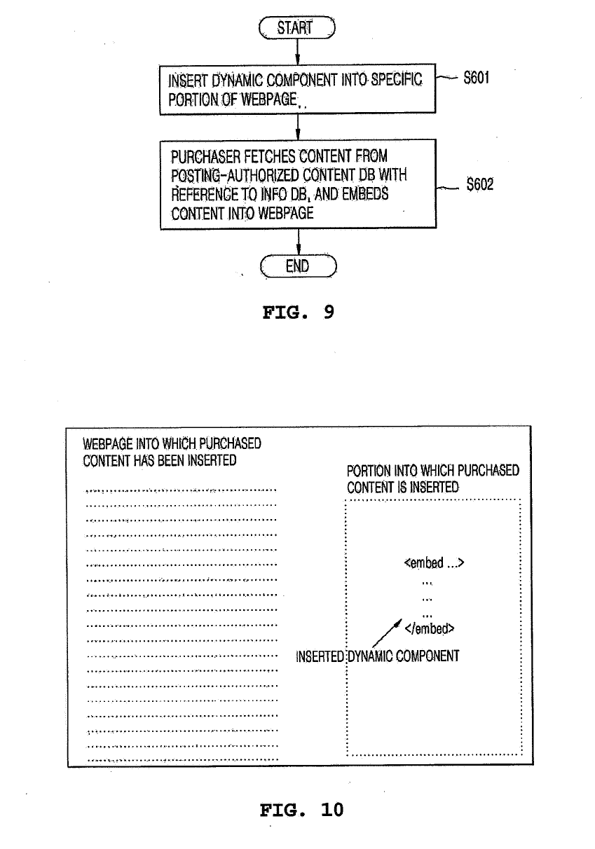

Steps S601 and 5602 of FIG. 9 are identical to the above-described steps S301 and 5302. This routine is different from that of the first embodiment only in that this routine uses a dynamic component, rather than a script code. FIG. 10 illustrates an example in which a dynamic component has been inserted.

However, the script code (for example, a JavaScript code) and the dynamic component (for example, a Flash component) are based on a method of linking (or referring) to the marketplace server, so that they can be deemed to be identical in functionality.

Although the present invention has been described and illustrated in conjunction with the preferred embodiments, which illustrate the technical spirit of the present invention, the present invention is not limited to the illustrated and described constructions and operations themselves, but those skilled in the art can readily appreciate that many variations and modifications can be made to the present invention without departing from the scope of the technical spirit. Accordingly, all such appropriate variations and modifications and the equivalents thereof must be considered to fall within the scope of the present invention.

### INDUSTRIAL APPLICABILITY

As a result, the present invention has advantages in that it provides the sellers of content with opportunities to make profits using only content substantially produced directly by the sellers themselves, and enables the construction of a network between sellers and purchasers.

Furthermore, the present invention has an advantage in that, in the case where a user uses a specific product, and writes and shares a piece of writing because the product suits his or her taste, the manufacturer of the product can purchase the shared content by paying a certain amount of money and post the content on his or her website, so that the author of the writing advertises the product while acting as a spokesperson for the product.

Accordingly, the places where “sneezer marketing” (“sneezer”: a person that likes a specific product and acts as a spokesperson for the product, actively advertising the product free of charge), which was previously difficult to perform, can be easily performed via marketplaces that can be provided to companies. That is, when content is posted on the website of a corresponding company in the case where the content is produced by producing writing, photos or moving images related to the experience of a specific product, the authors of the content may advertise the fact that their content has been posted on the website offline, and buzz marketing can be naturally performed through the propagation of the content.

Furthermore, experience-related content related to products allows various persons, visiting the homepage of the company, to find media, such as writing, photos or moving images that are produced by other persons having experience related to the products of the company, thereby influencing the purchase decision-making of the persons.

Furthermore, the present invention has an advantage of providing content producers with places for selling content produced by the content producers, thereby providing the content producers with a motivation to produce high-quality content. That is, in the case where service is provided such that a trade can be Performed not only when the informative feature of a writing is excellent but also when a purchaser determines that a simple single photo is useful (for example, in the case where content capable of stimulating the emotion of persons is used in emotional marketing), more effective marketing can be achieved using such content. In this respect, the production of a lot of excellent content can be promoted in various fields, other than the cases related to the utility of informative writing.

Furthermore, the present invention has an advantage in that new meta-sites, such as webzines, can be easily produced by collecting various content.

Moreover, the present invention has an advantage in that it provides the space for selling and purchasing various online content and provides a platform for allowing purchased content to be easily inserted into homepages using only a simple script code or a single dynamic component, therefore the possibility of selling and purchasing content, which has been previously limited to media such as music and movies, can be extended to content produced by general users.

1. An online content marketplace system comprising a content sale means (100), a content purchase means (200), content marketplace server (300), and a data communication network (400), wherein:
the content marketplace server (300) comprises:
a posting-authorized content DB (305) for storing content, authorized for posting by content sellers, in association with seller IDentification (ID) information; a content posting authorization message reception module (315) for checking whether a content posting authorization message is received from the content seller terminal 110, and creating and outputting uploading information for content authorized for posting if the content posting authorization message is received; a sale content collection module (317) for checking whether uploading information is input from the posting authorization message reception module (315), and, if the uploading information is input, collecting content corresponding to the uploading information and then registering and managing the content in the posting-authorized content DB (305) in association with the seller ID information; and a content sale module (321) for providing a service so that a certain purchaser can search and scan the content registered in the posting-authorized content DB (305) and purchase certain content based on results of the searching and scanning.

2. The online content marketplace system as set forth in claim 1, wherein the sale content collection module (317) checks whether a specific token or specific metadata is included in content posted on a web, and, if, as a result of the determination, the specific token or metadata is determined to be included, collecting the content and then registering and managing the content in the posting-authorized content DB (305) in association with the seller ID information.

3. The online content marketplace system as set forth in claim 1, wherein the content collection module (317) creates and manages document ID information for the content the posting of which is authorized by the sellers.

4. The online content marketplace system as set forth in claim 1, wherein the online content marketplace server further comprises:
a content posting webpage link module for, when specific content is sold, including link information for a webpage on which the sold content was posted in the sold content, so that the webpage can be accessed when the content is clicked on.

5. A method of operating an online content marketplace system, comprising the steps of:
(1) a content marketplace server determining whether a content posting authorization message is received;
(2) the content marketplace server, if, as a result of the determination, the content posting authorization message is received, detecting content information and a current location of the content via the posting authorization message;
(3) the content marketplace server collecting the content using the detected content information and the current location of the content; and
(4) the content marketplace server issuing and assigning document ID information to the collected content, registering and managing the ID information of the content in a content seller information DB, and registering and managing the content itself in a posting-authorized content DB.

6. The method as set forth in claim 5, wherein, if as a result of the termination at step (1), the content posting authorization message is not received, the content marketplace server searches web content, determines whether a specific token or metadata is included in the searched content, and performs step (3) of collecting data if, as a result of the determination, the specific token or metadata is included in the content.

7. A method of operating an online content marketplace system, comprising the steps of:
(1) a content marketplace server, when a content purchaser makes online access, providing a service so that the content purchaser can search and scan content registered in a posting-authorized content DB (305) using meta-information and index information;
(2) the content marketplace server, when the user completes the searching and scanning, providing result screens;
(3) the content marketplace server determining whether the content purchaser has selected specific content on the result screen;
(4) the content marketplace server, if the specific content has been selected, providing a webpage that, refers to the selected content;
(5) the content marketplace server determines whether the content purchaser desires to purchase the specific content on the result screen;
(6) the content marketplace server, if the specific content is desired to purchase, providing a payment window to a content purchaser terminal, and allowing payment to be performed;
(7) the content marketplace server determines whether a payment completion signal is input; and
(8) the content marketplace server, if the payment is completed, providing a service so that the purchased content can be posted on a content purchaser webpage.

8. The method as set forth in claim 7, further comprising the step of:
(9) the content marketplace server, if the sale of content is completed, registering ID information of the sold content in a sold content DB, thereby updating sale-related information.

9. A method of operating an online content marketplace system, comprising the steps of:
(1) inserting a simple script code, such as a JavaScript Code, or a dynamic component, such as a Flash component, into a specific portion of a webpage; and
(2) the script code or dynamic component detecting ID information of corresponding content via a purchaser information DB, searching for the content, registered in a posting-authorized content DB, using the detected ID information of the content, fetching the content, and embedding the content in a corresponding region of a purchaser webpage (220);
therefore the purchased content is automatically embedded in a website.

10. A method of operating an online content marketplace system, comprising the steps of:
(1) a content seller completing reproduction of content by inserting a script or a dynamic component, and referer information into a specific portion of the content, posting of which will be authorized by him or her, using a content seller terminal;
(2) the content seller terminal loading a webpage, including the produced content;
(3) determining whether the loaded script or dynamic component can detect information, including an address of a page to which the script or dynamic component belongs, and sending a posting authorization message, including the page address and information about a current page (additional information), to a content marketplace server;
(4) the content marketplace server makes access to the webpage, into which the script or component has been inserted based on the additional information, and receiving information, including the content itself, the address and metadata; and
(5) the content marketplace server determining whether the script or dynamic component has been first loaded, and, if it has been first loaded, detecting a current location of the content and then storing it in the posting-authorized content DB.

11. The method as set forth in claim 10, further comprising the steps of:
if, as a result of the determination at step (3), the information cannot be detected,
(6) content marketplace server determines whether to an address of a page, onto which referer information is loaded, using a web server, and, if the address can be detected, extracting an address of a page, into which a corresponding script or component has been inserted, based on the web server log; and
(7) the content marketplace server accessing a website corresponding to the address of the page extracted at step (6), and fetching additional information, such as the content, an address and metadata.

12. A method of operating an online content marketplace system, comprising the steps of:
(1) a content marketplace server receiving purchase condition information from a content purchase terminal accessed online, and storing the purchase condition information in a purchaser information DB;
(2) an automatic content purchase module of the content marketplace server determining whether the posting-authorized content and metadata thereof conform with the stored purchase condition information, and, if they conform with the purchase condition information, updating sales information by registering ID information of the content in a sold content DB; and
(3) a purchaser-based content management module of the content marketplace server adding the ID information of the content to an authorized content DB;
therefore a content purchaser can purchase content corresponding to the purchase condition information offline.
